(19) United States
(12) Patent Application Publication
(10) Pub. No.: US 2020/0149453 A1
(43) Pub. Date: May 14, 2020

(54) METHOD FOR THE AFTERTREATMENT OF THE EXHAUST GAS OF AN INTERNAL COMBUSTION ENGINE AND INTERNAL COMBUSTION ENGINE

(71) Applicant: MAN Energy Solutions SE, Augsburg (DE)

(72) Inventor: Andreas Döring, München/Unterhaching (DE)

(73) Assignee: MAN Energy Solutions SE

(21) Appl. No.: 16/676,725

(22) Filed: Nov. 7, 2019

(30) Foreign Application Priority Data
Nov. 12, 2018 (DE) 102018128152.8

(51) Int. Cl. F01N 3/28; B01D 53/56

(52) U.S. Cl. CPC F01N 3/2803; B01D 53/565

(57) ABSTRACT

A method for the aftertreatment of the exhaust gas of an internal combustion engine combusting gaseous fuel. The exhaust gas is conducted via a CH₄-oxidation catalytic converter, which for the CH₄-oxidation and accordingly as catalytically active compound includes a pyrochlore and/or a beta polymorphous A-type (BEA) zeolite and/or a cobalt-nickel oxide. The exhaust gas to be conducted via the CH₄-oxidation catalytic converter has an NO₂ proportion, based on a total proportion of nitrogen oxides, of at least 15%.

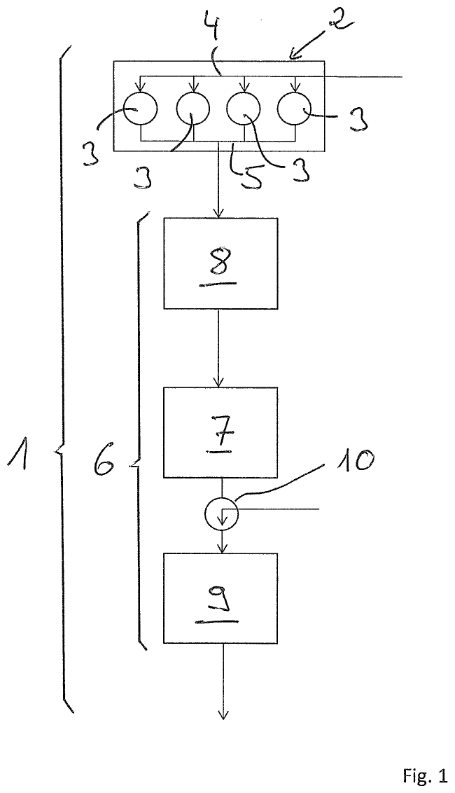

### BACKGROUND OF INVENTION

### 1, Field of the Invention

The method relates to a method for the aftertreatment of exhaust gas of an internal combustion engine combusting a gaseous fuel, namely of a gas engine or a dual-fuel engine operated in the gas fuel operating mode. The invention, furthermore, relates to an internal combustion engine, namely to a gas engine or dual-fuel engine.

### 2. Description of Related Art

In gas engines and in dual-fuel engines in the gas fuel operating mode, a gaseous fuel, such as, for example natural, gas, is combusted. With such internal combustion engines combusting a gaseous fuel, undesirable emissions of CH₄ (methane) can occur because of an incomplete combustion of the gaseous fuel. Since methane represents a strong greenhouse gas, the CH₄ emissions into the environment have to be kept as low as possible with internal combustion engines combusting a gaseous fuel.

From practice it is known to conduct the exhaust gas, which leaves the cylinders of an internal combustion engine combusting a gaseous fuel via a CH₄-oxidation catalytic converter, to replace the CH₄ in the CH₄-oxidation catalytic converter. In internal combustion engines known from practice, in particular platinum and/or palladium are employed in the CH₄-oxidation catalytic converter for the CH₄-oxidation and accordingly as catalytically active compounds with metals of the platinum group. Typically, the charging of the CH₄-oxidation catalytic converter with a metal of the platinum group typically amounts to more than 7 grams of platinum and/or palladium per litre of volume of the CH₄-oxidation catalytic converter in internal combustion engines known from practice, which causes high costs.

Furthermore, the operating time of such CH₄-oxidation catalytic converters known from practice is relatively short since sulphur oxides, which can enter the region of the CH₄-oxidation catalytic converter, can deactivate the catalytically active compounds of the platinum metal group. For this reason, the possibility of the reduction of the CH₄ emissions is limited with internal combustion engines known from practice.

From DE 10 2015 001 495 A1 a method for operating an internal combustion engine is known, in which a gaseous fuel is combusted. Exhaust gas is conducted via a CH₄-oxidation catalytic converter, wherein the NO₂ proportion in the exhaust gas is adjusted so that upstream of the CH₄-oxidation catalytic converter the NO₂ proportion in the total nitrogen oxides in the exhaust gas amounts to at least 15%.

The CH₄-oxidation catalytic converter of DE 10 2015 001 495 A1 preferentially comprises, for the CH₄-oxidation, Cer and/or cobalt and/or copper and/or iron as active components, which are preferentially embedded in a zeolite matrix of the structures MOR, FER, PER, NFI, LTL, LAU, CHI or CHK.

### SUMMARY OF THE INVENTION

There is a need for further improving the decomposition of CH₄ in the exhaust gas in order to reduce CH₄ emissions on internal combustion engines operated with a gaseous fuel.

One aspect of the invention is a new type of method for the aftertreatment of the exhaust gas of an internal combustion engine combusting a gaseous fuel and a corresponding internal combustion engine.

According to one aspect of the invention, the exhaust gas is conducted via a CH₄-oxidation catalytic converter, which for the CH₄-oxidation and accordingly at catalytically active compound comprises a pyrochlore and/or a beta polymorphous A-type (BEA) zeolite and/or a cobalt-nickel oxide.

According to one aspect of the invention, the exhaust gas to be conducted via the CH₄-oxidation catalytic converter has an NO₂ proportion, based on the total proportion of nitrogen oxides, of at least 15%.

According to one aspect of the invention, the exhaust gas of the internal combustion engine, in which a gaseous fuel is combusted, is conducted, for the reduction of the CH₄ emissions, with a defined NO₂ proportion via the CH₄-oxidation catalytic converter which for the CH₄-oxidation and accordingly as catalytically active compound comprises a pyrochlore and/or a BEA zeolite and/or a cobalt-nickel oxide. Here, the invention is based on the realisation that with such a CH₄-oxidation catalytic converter, CH₄ can be optimally decomposed using at least one of the above catalytically active compounds namely in particular when the NO₂ proportion in the exhaust gas to be conducted via the CH₄-oxidation catalytic converter, i.e. upstream of the CH₄-oxidation catalytic converter, based on the total proportion of nitrogen oxides amounts to at least 15%.

According to an advantageous further development, the CH₄-oxidation catalytic converter accordingly comprises pyrochlore as catalytically active compound for the CH₄-oxidation. Preferentially, the pyrochlore comprises at least one pyrochlore which is selected from the following group: Sm₂Zr₂O₇, Sm₂Mo₂O₇, La₂Ti₂O₇, La₂CoₓSn₂₋ₓO_{7-δ}, La₂CoₓZr₂₋ₓO_{7-δ}, Mn₂CoₓZr₂₋ₓO_{7-δ}, Pr₂Ru₂O₇, ZrTiGd₂O₇, Pr₂Co₂O₇ and Pr₂CoₓZr₂₋ₓO_{7-δ} wherein 0≤δ≤2. Such a CH4-oxidation catalytic converter, combined with the NO2 proportion in the exhaust gas adjusted in a defined manner upstream of the CH₄-oxidation catalytic converter an optimal decomposition of CH4.

According to an advantageous further development, elements of the pyrochlore and/or of the beta polymorphous A-type (BEA) zeolite substituted with metals of the rare earths and/or iron and/or cobalt and/or nickel and/or copper. This also serves for the optimal decomposition of CH₄ in the CH₄-oxidation catalytic converter.

According to an advantageous further development, the CH₄-oxidation catalytic converter comprises a cobalt-nickel compound CoₓNi_{y}, preferably as oxide for the CH₄-oxidation and accordingly as catalytically active compound, wherein 1≤x≤10, preferably 1≤x≤4, wherein 0≤y≤9, preferably 1≤y≤4 and wherein preferentially x+y≤10, preferably x+y≤8, particularly preferably x+y≤6. With such a cobalt-nickel oxide as catalytically active compound in the CH₄-oxidation catalytic converter, CH₄ can also be optimally decomposed namely in particular when the No₂ proportion in the exhaust gas upstream of the CH₄-oxidation catalytic converter, based on the total proportion of nitrogen oxides, amounts to at least 15%.

According to an advantageous further development, the NO₂ proportion in the exhaust gas is adjusted via at least one combustion parameter of the internal combustion engine combusting the gaseous fuel and/or upstream of the CH₄-oxidation catalytic converter via NO-oxidation catalytic converter. By way of this, the NO₂ proportion in the exhaust gas can be particularly advantageously adjusted upstream of the CH₄-oxidation catalytic converter.

According to an advantageous further development, the exhaust gas upstream of the CH₄-oxidation catalytic converter is conducted via an SCR catalytic converter, wherein downstream of the CH₄-oxidation catalytic converter and upstream of the SCR catalytic converter NH₃ or an NH₃ precursor substance is introduced into the exhaust gas. By way of the SCR catalytic converter, the nitrogen oxide proportion can be subsequently reduced in the exhaust gas that has already been conducted via the CH₄-oxidation catalytic converter.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:
The FIGURE is a highly schematised view of an internal combustion engine according to the invention for illustrating the method according to the invention for the aftertreatment of the exhaust gas of the internal combustion engine.

### DETAILED DESCRIPTION OF THE PRESENTLY PREFERRED EMBODIMENTS

The invention relates to an internal combustion engine, in which a gaseous fuel is combusted. Furthermore, the invention relates to a method for aftertreating the exhaust gas of the internal combustion engine combusting the gaseous fuel.

The FIGURE shows a highly schematised diagram of an internal combustion engine 1 according to one aspect of the invention. The internal combustion engine 1 comprises at least one cylinder block 2 with cylinders 3. In the cylinders 3 of the internal combustion engine 1, a gaseous fuel is combusted such as for example natural gas. The internal combustion engine 1 is either a gas engine or a dual-fuel engines operated in the gas fuel operating mode.

The FIGURE visualises with a feed 4, that gaseous fuel is fed to the cylinders 3 of the internal combustion engine, in particular a mixture of charge air and gas. A discharge 5 visualises that exhaust gas generated during the combustion is discharged from the cylinders 3 and conducted via an exhaust gas aftertreatment system 6 of the internal combustion engine 1.

The exhaust gas aftertreatment system 6 comprises a CH₄-oxidation catalytic converter 7. For the CH₄-oxidation and accordingly as catalytically active compound, the CH₄-oxidation catalytic converter comprises a pyrochlore and/or a beta polymorphous A-type (BEA) zeolite and/or a cobalt-nickel oxide.

The exhaust gas to be conducted via the CH₄-oxidation catalytic converter 7 comprises an NO₂ proportion, based on the total proportion of nitrogen oxides in the exhaust gas of at least 15%, preferably of at least 30%, particularly preferably of at least 50%.

In the shown exemplary embodiment, the exhaust gas aftertreatment system 6 comprises an NO-oxidation catalytic converter 8 upstream of the CH₄-oxidation catalytic converter 7 in order to initially conduct the exhaust gas leaving the cylinders 3 of the internal combustion engine 1 via an NO-oxidation catalytic converter 8 and, with the help of the NO-oxidation catalytic converter 8, adjust the proportion of NO₂ in the exhaust gas, based on the total proportion of nitrogen oxides in the exhaust gas, to at least 15%, preferably to at least 30%, particularly preferably to at least 50%.

Alternatively or additionally to the NO-oxidation catalytic converter 8, the NO₂ proportion in the exhaust gas can also be adjusted via a combustion parameter of the internal combustion engine 1 combusting the gaseous fuel.

According to an advantageous further development of the invention, the CH₄-oxidation catalytic converter comprises at least pyrochlore for the CH₄-oxidation.

Here, the pyrochlore comprises at least a pyrochlore which is selected from the following group:
Sm₂Zr₂O₇,
Sm₂Mo₂O₇,
La₂Ti₂O₇,
La₂CoₓSn₂₋ₓO_{7-δ},
La₂CoₓZr₂₋ₓO_{7-δ},
Mn₂CoₓZr₂₋ₓ O_{7-δ},
Pr₂Ru₂O₇,
ZrTiGd₂O₇,
Pr₂Co₂O₇, and
Pr₂CoₓZr₂₋ₓO_{7-δ},
wherein 0≤δ≤2.

According to an advantageous further development of the invention, the CH₄-oxidation catalytic converter comprises a beta polymorphous A-type (BEA)zeolite in addition or alternatively to the pyrochlore.

In particular when the CH4-oxidation catalytic converter comprises pyrochlore and/or BEA zeolite for the CH₄-oxidation and accordingly as catalytically active compound, elements of the pyrochlore and/or of the BEA zeolite are substituted preferentially with metals of the rare earths and/or with iron and/or with cobalt and/or with nickel and/or with copper. Furthermore, the pyrochlore and/or BEA zeolite can be enriched with Rh, Ru, Ir, Os, Bi, Zn, Gd in that these elements are used in the pyrochlore and/or BEA zeolite.

Furthermore, by the addition of alkali metals and earth alkali metals, the thermal stability of the CH₄-oxidation catalytic converter 7 can be increased. In addition to the pyrochlore and/or the BEA zeolite, the CH₄-oxidation catalytic converter 7 can thus also comprise alkali metals and earth alkali metals.

According to a further advantageous further development of the invention, the CH₄-oxidation catalytic converter 7, for the CH₄-oxidation and accordingly as catalytically active compound, comprises a cobalt-nickel compound CoₓNi_{y}, wherein the oxidic form has proved to be advantageous.

The following applies to the cobalt-nickel compound CoₓNi_{y}:

1≤x≤10, preferably 1≤x≤4,
0≤y≤9, preferably 1≤y≤4,
X+y≤10, preferably x+y≤8, particularly preferably x+y≤6.

The cobalt-nickel compound CoₓNi_{y}, in particular its oxide, can be present alternatively or additionally to the pyrochlore and/or to the beta polymorphous A-type (BEA) zeolite.

As substrate for the abovementioned catalytically active components Al₂O₃, TiO₂, SiO₂ and Wo₃ are possible individually or combined.

In the exemplary embodiment, an SCR catalytic converter 9 is arranged downstream of the CH₄-oxidation catalytic converter, via which the exhaust gas, which leaves the CH₄-oxidation catalytic converter 7, is conducted for reducing the nitrogen oxide proportion in the exhaust gas. There, an introduction device 10 for introducing NH₃ or NH₃ precursor substance into the exhaust gas is arranged seen in the flow direction of the exhaust gas downstream of the CH₄-oxidation catalytic converter 7 and upstream of the SCR catalytic converter 9, in order to effectively remove or reduce nitrogen oxides in the exhaust gas in the region of the SCR catalytic converter 9.

With the invention present here an effective decomposition of CH₄ in the exhaust gas of an internal combustion engine combusting gaseous fuel is possible, namely without the necessity of using metals of the platinum metal groups such as for example platinum and/or palladium in the region of the CH₄-oxidation catalytic converter.

The proportion of platinum and palladium in the catalytically active components utilised for the decomposition of CH₄ is smaller than 5%, preferably smaller than 3%, most preferably smaller than 1% in each case. According to an advantageous further development, the proportion of the sum of platinum and palladium in the active components utilised for the CH₄ decomposition is smaller than 5%, advantageously smaller than 3%, most advantageously smaller than 1%.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for aftertreatment of an exhaust gas of an internal combustion engine, comprising:
combusting a gaseous fuel;
conducting the exhaust gas via a CH₄-oxidation catalytic converter which for CH₄-oxidation and accordingly as catalytically active compound comprises a pyrochlore and/or a beta polymorphous A-type (BEA) zeolite and/or a cobalt-nickel compound,
wherein the exhaust gas to be conducted via the CH₄-oxidation catalytic converter has an NO₂ proportion, based on a total proportion of nitrogen oxides, of at least 15%.

2. The method according to claim 1, wherein the exhaust gas to be conducted via the CH₄-oxidation catalytic converter, upstream of the CH₄-oxidation catalytic converter, has an NO₂ proportion, based on a total proportion of nitrogen oxides, of at least one of 30% and 50%.

3. The method according to claim 1, wherein the CH₄-oxidation catalytic converter for the CH₄-oxidation comprises pyrochlore.

4. The method according to claim 3, wherein the pyrochlore comprises at least a pyrochlore selected from the group consisting of:
Sm₂Zr₂O₇,
Sm₂Mo₂O₇,
La₂Ti₂O₇,
La₂CoₓSn₂₋ₓO_{7-δ},
La₂CoₓZr₂₋ₓO_{7-δ},
Mn₂COₓZr₂₋ₓ O_{7-δ},
Pr₂Ru₂O₇,
ZrTiGd₂O₇,
Pr₂Co₂O₇, and
Pr₂CoₓZr₂₋ₓO_{7-δ},
wherein 0≤δ≤2.

5. The method according to claim 1, wherein elements of the pyrochlore and/or of the beta polymorphous A-type (BEA) zeolite are substituted with metals of rare earths and/or iron and/or cobalt and/or nickel and/or copper.

6. The method according to claim 1, wherein the -oxidation catalytic converter for the CH₄-oxidation comprises a cobalt-nickel compound COₓNi_{y}, in its oxidic form,
wherein x is at least one of:
1≤x≤10, and
1≤x≤4, and
Wherein y is at least one of:
0≤y≤9, and
1≤y≤4.

7. The method according to claim 6, wherein at least one of:
x+y≤10,
x+y≤8, and
x+y≤6≤.

8. The method according to claim 1, wherein at least one of:
the No₂ proportion in the exhaust gas is adjusted via at least one combustion parameter of the internal combustion engine combusting the gaseous fuel, and
the NO₂ proportion in the exhaust gas upstream of the CH₄-oxidation catalytic converter is adjusted via a NO-oxidation catalytic converter.

9. The method according to claim 1, further comprising:
conducting the exhaust gas downstream of the CH₄-oxidation catalytic converter via an SCR catalytic converter; and
introducing NH₃ or an NH₃ precursor substance into the exhaust gas downstream of the CH₄-oxidation catalytic converter and upstream of the SCR catalytic converter.

10. An internal combustion engine, configured as one of a gas engine and a dual-fuel engine, comprising:
cylinders, in which a gaseous fuel is combustible; and
a CH₄-oxidation catalytic converter, via which exhaust gas is conductible, which for CH₄-oxidation and accordingly as catalytically active compound comprises a pyrochlore and/or a beta polymorphous A-type (BEA) zeolite and/or a cobalt-nickel compound;
wherein the internal combustion engine and/or upstream of the CH₄-oxidation catalytic converter an NO-oxidation catalytic converter in the exhaust gas to be conducted via the CH₄-oxidation catalytic converter adjusts an NO₂ proportion based on a total proportion of nitrogen oxides of a least 15%.

11. The internal combustion engine according to claim 10,
wherein the CH₄-oxidation catalytic converter for CH₄-oxidation comprises pyrochlore,
wherein the pyrochlore comprises at least one pyrochlore selected from the group consisting of:
Sm₂Zr₂O₇,
Sm₂Mo₂O₇,
La₂Ti₂O₇,
La₂CoₓSn₂₋ₓO_{7-δ},
La₂CoₓZr₂₋ₓO_{7-δ},
Mn₂CoₓZr₂₋ₓO_{7-δ},
Pr₂Ru₂O₇,
ZrTiGd₂O₇,
Pr₂Co₂O₇, and
Pr₂CoₓZr₂₋ₓO_{7-δ},
wherein 0≤δ≤2.

12. The internal combustion engine according to claim 10, wherein the CH₄-oxidation catalytic converter for the CH₄-oxidation comprises a cobalt-nickel compound CoₓNi_{y}, in its oxidic form,
wherein x is at least one of:
1≤x≤10, and
1≤x≤4, and
Wherein y is at least one of:
0≤y≤9, and
1≤y≤4.

13. The internal combustion engine according to claim 10, wherein elements of the pyrochlore and/or of the beta polymorphous A-type (BEA) zeolite are substituted with metals of rare earths and/or iron and/or cobalt and/or nickel and/or copper.

14. The internal combustion engine according to claim 10, further comprising:
an SCR catalytic converter arranged downstream of the CH₄-oxidation catalytic converter; and
an introduction device arranged downstream of the CH₄-oxidation catalytic converter and upstream of the SCR catalytic converter configured to introduce NH₃ or an NH₃ precursor substance into the exhaust gas.

15. The method according to claim 1, wherein the internal combustion engine is one of a gas engine and a dual-fuel engine operated in a gas fuel operating mode.

16. The internal combustion engine according to claim 12, wherein at least one of:
x+y≤10,
x+y≤8, and
x+y≤6.
